(19) United States
(12) Patent Application Publication
(10) Pub. No.: US 2026/0253406 A1
(43) Pub. Date: Aug. 27, 2026

(54) ACCURATE AND MULTI-SCALE MATERIAL SELECTION IN DIGITAL IMAGES

(71) Applicant: Adobe Inc., San Jose, CA (US)

(72) Inventors: Julia Guerrero Viu, Zaragoza (ES); Valentin Deschaintre, London (GB); Iliyan Georgiev, London (GB); Elena Garces Garcia, Paris (FR)

(21) Appl. No.: 19/059,847

(22) Filed: Feb. 21, 2025

(51) Int. Cl. G06V 10/94; G06V 10/26; G06V 10/52; G06V 10/75; G06V 10/77; G06V 10/82; G06V 20/70

(52) U.S. Cl. CPC G06V 10/945; G06V 10/26; G06V 10/52; G06V 10/75; G06V 10/7715; G06V 10/82; G06V 20/70

(57) ABSTRACT

The present disclosure is directed toward systems, methods, and non-transitory computer readable media that generate, for display via a graphical user interface, a digital image portraying a variety of materials, wherein one of the materials includes a first sub-material and a second sub-material which are visually distinct. The disclosed systems receive, via an interaction with the graphical user interface, a selection of a location on the digital image corresponding to the first sub-material. Furthermore, the disclosed systems generate, based on the selection and utilizing a material detection neural network, a first material selection that includes an indication of pixels of the digital image displaying the material and a second material selection that includes an indication of pixels of the digital image displaying the first sub-material. In addition, the disclosed systems provide, via the graphical user interface, the first material selection and the second material selection.

### BACKGROUND

Advancements in computing devices and digital content design systems have led to innovative developments in computer image design and design software. For example, certain digital content design applications provide interfaces for interacting with the content of digital images to create a variety of visual designs. In some cases, existing workflows of digital content design applications facilitate actions such as selecting, adding, removing, or adjusting the pixel content of digital images. In some cases, exiting digital design applications provide options within a graphical user interface to interact with regions of a digital image based on user selections. However, despite these advances, existing image editing systems have a number of shortcomings with regard to accuracy and flexibility when selecting pixel regions based on the types of materials and sub-materials displayed within a digital image.

### SUMMARY

One or more embodiments provide benefits and/or solve one or more of the foregoing or other problems in the art with systems, methods, and non-transitory computer readable storage media that generate a hierarchical material selection for a digital image indicating the pixels of the digital image that share the same material and the pixels of the digital image that share the same sub-material. For example, based on a selection of a location in the digital image, the disclosed systems utilize a material detection neural network to generate a material selection that includes the pixels of the digital image that display the material. Furthermore, in some embodiments, the disclosed systems utilize the material detection neural network to generate a sub-material selection that includes the pixels of the digital image that display a sub-material at the location. In certain cases, the disclosed systems generate and aggregate multi-scale features of the digital image at multiple resolutions to generate the material selection and the sub-material selection. In some embodiments, the disclosed systems provide the material selection and the sub-material selection for display via a graphical user interface.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a multi-scale selection system in accordance with one or more embodiments;

FIG. 2 illustrates an example overview of generating a material selection and a sub-material selection for a location in a digital image in accordance with one or more embodiments;

FIG. 3 illustrates an example of utilizing an encoder of a material detection neural network to generate multi-scale features for multiple resolutions of a digital image in accordance with one or more embodiments;

FIG. 4 illustrates an example of utilizing an aggregation module of a material detection neural network to generate multi-scale aggregated features by aggregating sets of multi-scale features in accordance with one or more embodiments;

FIGS. 5A-5B illustrate an example of utilizing a decoder of a material detection neural network to generate a material selection and a sub-material selection from aggregated multi-scale features in accordance with one or more embodiments;

FIG. 6 illustrates an example of hierarchical training data the multi-scale selection system uses to train a material detection neural network to generate a material selection and a sub-material selection in accordance with one or more embodiments;

FIGS. 7A-7B illustrate an example of the multi-scale selection system utilizing a graphical user interface to display a material selection and a sub-material selection for a location in a digital image in accordance with one or more embodiments;

FIGS. 8A-8B illustrate an example of the multi-scale selection system utilizing a graphical user interface to display a material selection that includes multiple objects utilizing an overlay and a binary mask in in accordance with one or more embodiments;

FIGS. 9A-9B illustrate qualitative comparisons of the accuracy of the multi-scale selection system with the accuracy of existing single-scale selection systems in accordance with one or more embodiments;

FIG. 10 illustrates a diagram of an example architecture of the multi-scale selection system in accordance with one or more embodiments;

FIG. 11 illustrates a flowchart of a series of acts for generating a transformed vector object for a vector object utilizing portals in accordance with one or more embodiments; and

FIG. 12 illustrates a block diagram of an example computing device in accordance with one or more embodiments.

### DETAILED DESCRIPTION

This disclosure describes one or more embodiments of a multi-scale selection system that generates a selection indicating pixels of a digital image that share the same material. For example, based on a location in a digital image (e.g., a query pixel), the multi-scale selection system utilizes a material detection neural network to generate a material selection indicating the pixels of the digital image that display the material (e.g., the fabric of a tablecloth or the wood of a chair) displayed at the location. Furthermore, in certain embodiments, the based on the location in the digital image, the multi-scale selection system utilizes the material detection neural network to generate a sub-material selection indicating the pixels of the digital image that display the sub-material (e.g., the stripes of a patterned fabric) displayed at the location. In one or more embodiments, the multi-scale selection system selects the pixels of the digital image that display the material (e.g., chairs and a table made of the same type of wood) and does not select the pixels of the digital image that display other materials that share a semantic class with the material (e.g., chairs and a table made of different types of wood). In some embodiments, the disclosed systems provide the material selection and the sub-material selection for display via a graphical user interface.

More specifically, the multi-scale selection system utilizes a material detection neural network to generate the material selection and the sub-material selection for a digital image. To enable accurate pixel selections for the material selection and the sub-material selection, in one or more embodiments, the multi-scale selection system generates multiple resolutions of an input image. From the multiple resolutions of the input image, the multi-scale selection system generates non-overlapping image partitions (e.g., image patches) representing localized regions of the image.

Furthermore, in one or more embodiments, the multi-scale selection system utilizes an encoder (e.g., a self-supervised vision transformer) of the material detection neural network to iteratively refine the image features of the image partitions. In one or more embodiments, for each of the image partitions, the encoder extracts global and local image features from the image partitions utilizing a series of transformer blocks. Furthermore, embodiments of the multi-scale selection system combine the global and local features of the digital image generated by each of transformer blocks. In addition, in certain embodiments, the multi-scale selection system utilizes upscaling operators to process the combined features at multiple scales to generate the multi-scale image features.

Furthermore, in one or more embodiments, the multi-scale selection system generates multi-scale aggregated features from the multi-scale image features. For example, the multi-scale selection system merges, upscales/downscales, and concatenates sets of the multi-scale image features at each scale to generate the multi-scale aggregated features. In some embodiments, the feature aggregation manager merges multi-scale image features generated from each resolution of the input image. Furthermore, embodiments of the multi-scale selection system upscale and/or downscale the merged multi-scale image features to a uniform resolution. Embodiments of the multi-scale selection system concatenate the scaled and merged multi-scale image features along a feature dimension to generate the aggregated multi-scale features.

In certain embodiments, the multi-scale selection system further refines the multi-scale aggregated features to generate the material selection and the sub-material selection. For example, the multi-scale selection system utilizes a decoder of the material detection neural network to generate weighted multi-scale aggregated features from the multi-scale aggregated features. More specifically, utilizing cross-similarity feature weighting on the multi-scale aggregated features, embodiments of the multi-scale selection system generate a material similarity score representing a per-pixel likelihood that the pixel displays the material and a sub-material similarity score representing a per-pixel likelihood that the pixel displays the sub-material. In certain cases, the multi-scale selection system compares the material similarity score to a material matching threshold to generate the material selection and the sub-material similarity score to a sub-material matching threshold to generate the sub-material selection. Embodiments of the multi-scale selection system provide the material selection and the sub-material selection for display on a graphical user interface (e.g., via a binary mask or an overlay).

As mentioned, existing design systems have a number of technical shortcomings, particularly in terms of accuracy and flexibility when selecting materials within digital images. For example, existing design systems are inflexible and do not include the ability to perform hierarchical material selections of materials and corresponding sub-materials based on a query location. Specifically, existing design systems lack tools that enable users to select a material while simultaneously isolating and selecting visually distinct sub-materials (e.g., subcomponents or regions) within the material based on a location of the digital image. To illustrate, when working with a patterned surface or a composite texture, existing design systems do not differentiate between broader material characteristics (such as the base material) and finer structural details (of sub-materials such as patterns, color gradients, or embedded elements). As a result of this lack, existing systems require multiple device interactions to create layered or context-aware selections that align with the hierarchical nature of real-world materials, introducing inefficiencies. This inability to generate hierarchical selections significantly limits the utility of existing systems, particularly for applications requiring detailed segmentation or hierarchical representations.

Furthermore, although some existing design systems provide interfaces to select materials in a digital image, existing design systems frequently exhibit inaccuracies when selecting the materials. For example, when handling material selections at material boundaries, existing design systems provide inaccurate pixel selections for locations corresponding to transitions between materials. These inaccuracies become particularly pronounced in digital images containing thin structures or fine details, where existing design systems often misclassify the boundary pixels. Additionally, existing design systems often inaccurately process digital images with high-frequency details or cluttered scenes, where overlapping textures, intricate patterns, or dense visual information confound the section process. Furthermore, existing design systems often provide inconsistent material selections at varying zoom levels. For instance, with existing design systems, a material region that appears correctly selected at one zoom level is often misclassified or fragmented at another zoom level.

As suggested above, embodiments of the multi-scale selection system overcome these and other disadvantages inherent in existing design systems. For example, by extracting multi-scale features across multiple resolutions of digital images, the multi-scale selection system improves upon the accuracy of existing design systems. Utilizing a layered multi-resolution analysis, the multi-scale selection system precisely defines material boundaries within digital images, even in cases where transitions between materials are subtle or involve intricate textures. Additionally, by analyzing the characteristics of materials across multiple resolutions, the multi-scale selection system enhances accuracy when selecting the material of thin structures, such as fine lines or narrow elements. Similarly, by utilizing multi-scale aggregated features captured across multiple resolutions, the multi-scale selection system isolates materials in visually dense scenes or multiple zoom levels more accurately, filtering out irrelevant details to isolate the selected material.

Furthermore, the multi-scale selection system enables the hierarchical selection of materials and sub-materials, which is not available in existing design systems. In particular, unlike existing design systems, which treat materials as singular entities, the multi-scale selection system employs a neural network trained identify and select materials based on shared SVBRDF (Spatially Varying Bidirectional Reflectance Distribution Function) characteristics and sub-materials based on shared BRDF (Bidirectional Reflectance Distribution Function) characteristics. By utilizing SVBRDF and BRDF characteristics, the multi-scale selection system isolates the materials and sub-materials while accounting for reflective highlights and matte regions within digital images.

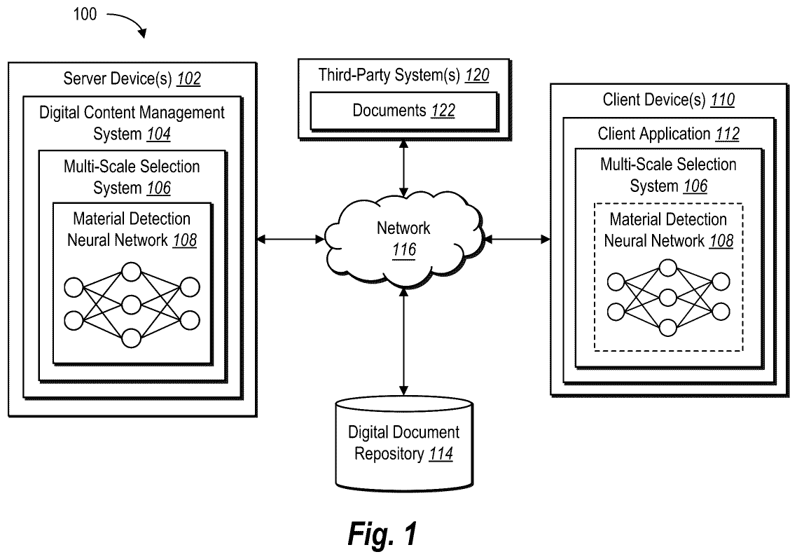

Additional detail regarding the multi-scale selection system will now be provided with reference to the figures. For example, FIG. 1 illustrates a schematic diagram of an exemplary system environment (e.g., environment 100) in which a multi-scale selection system 106 operates. As illustrated in FIG. 1, the environment 100 includes server device(s) 102, a network 116, client device(s) 110, digital document repository 114, and third-party system(s) 120.

Although the environment 100 of FIG. 1 is depicted as having a particular number of components, the environment 100 is capable of having any number of additional or alternative components (e.g., any number of servers, client devices, or other components) in communication with the multi-scale selection system 106 via the network 116. Similarly, although FIG. 1 illustrates a particular arrangement of the server device(s) 102, the network 116, the client device(s) 110, the digital document repository 114, and the third-party system(s) 120, various additional arrangements are possible.

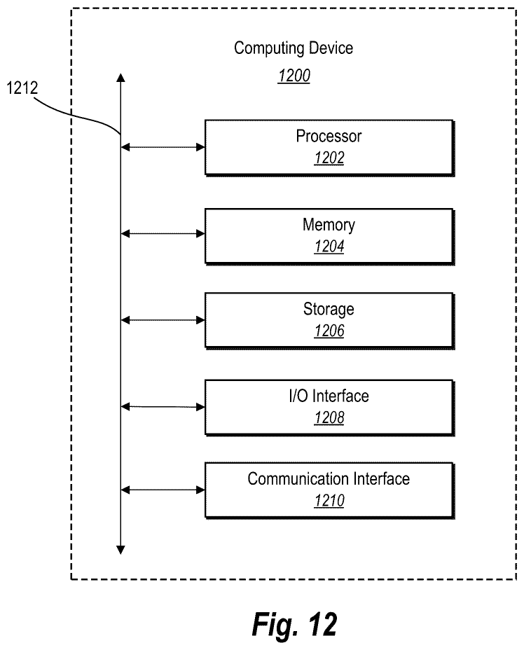

The server device(s) 102, the network 116, the client device(s) 110, the digital document repository 114, and the third-party system(s) 120 are communicatively coupled with each other either directly or indirectly (e.g., through the network 116 discussed in greater detail below in relation to FIG. 12). Moreover, the server device(s) 102 and the client device(s) 110 include one of a variety of computing devices (including one or more computing devices as discussed in greater detail with relation to FIG. 12).

As illustrated in FIG. 1, the environment 100 includes the server device(s) 102 and the digital content management system 104. The server device(s) 102 utilizes the digital content management system 104 to generate, track, store, process, receive, and transmit electronic data including digital images, material selections, and sub-material selections. For example, the server device(s) 102 receives or monitors interactions across the client device(s) 110. In some embodiments, the server device(s) 102 transmits content to the client device(s) 110 to cause the client device(s) 110 to display content associated with generating material selections and sub-material selections. For example, the server device(s) 102 presents the material selections and sub-material selections to client device(s) 110 and displays the material selections and sub-material selections on the client device(s) 110 with the material selections and sub-material selections displayed corresponding to system need (e.g., provides material selections and sub-material selections for display via the client application 112). The server device(s) 102 further accesses and utilizes the digital document repository 114 to store and retrieve information such as digital images, material selections, sub-material selections, and/or other data.

Additionally, the server device(s) 102 includes all, or a portion of, the multi-scale selection system 106. For example, the multi-scale selection system 106 operates on the server device(s) 102 to access digital content (including digital images, material selections, sub-material selections), determine digital content changes, and provide localization of content changes to the client device(s) 110. In one or more embodiments, via the server device(s) 102, the multi-scale selection system 106 generates and displays digital images, material selections, sub-material selections based on the client device(s) 110 input. Example components of the multi-scale selection system 106 will be described below with regard to FIG. 12.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 12. Some embodiments of client device(s) 110 are operated by a user to perform a variety of functions via client application 112 such as the generation of the material selections and sub-material selections. The client device(s) 110 include one or more applications (e.g., the client application 112) that access, edit, modify, store, and/or provide, for display, digital images, material selections, and sub-material selections. For example, in some embodiments, the client application 112 includes a software application installed on the client device(s) 110. In other cases, however, the client application 112 includes a web browser or other application that accesses a software application hosted on the server device(s) 102.

In some embodiments, the multi-scale selection system 106 on the server device(s) 102 supports the client application 112 on client device(s) 110. For instance, in some cases, the multi-scale selection system 106 on the server device(s) 102 trains the material detection neural network 108. The multi-scale selection system 106, via the server device(s) 102, provides the trained the material detection neural network 108 to the client device(s) 110. In other words, the client device(s) 110 obtains (e.g., downloads) the material detection neural network 108 from the server device(s) 102 that is already trained/optimized. Once downloaded, the material detection neural network 108 on the client device(s) 110 is able to make material selections independent from the server device(s) 102. In one or more alternative implementations, the multi-scale selection system 106 generates or learns parameters for the material detection neural network 108 in whole or in part on the client device(s) 110.

In alternative implementations, the multi-scale selection system 106 includes a web hosting application that allows the client device(s) 110 to interact with content and services hosted on the server device(s) 102. To illustrate, in one or more implementations, the client device(s) 110 accesses a software application supported by the server device(s) 102. In response, digital content management system 104 on the server device(s) 102 provides tools for performing image editing tasks, including but not limited to material selection. In other words, the client device(s) 110 does not have to download the material detection neural network 108 while still being able to access/utilize the trained/optimized tools provided by the multi-scale selection system 106 via a web hosting application. To illustrate, in one or more embodiments, the client device(s) 110 accesses a web page or computing application supported by the server device(s) 102. The client device(s) 110 provides input to the server device(s) 102 (e.g., user interactions). In response, the multi-scale selection system 106 on the server device(s) 102 generates material selections and sub-material selections. The server device(s) 102 provides the material selections and sub-material selections to the client device(s) 110.

In some embodiments, the multi-scale selection system 106 includes the third-party system(s) 120 and documents 122. To illustrate, in one or more embodiments, the multi-scale selection system 106 interacts with content and services hosted on the third-party system(s) 120. To illustrate, in one or more embodiments, the multi-scale selection system 106 accesses a web page or computing application supported by the third-party system(s) 120. The third-party system(s) 120 provide input to the multi-scale selection system 106 and documents 122 (e.g., digital images). In response, the multi-scale selection system 106 generates/modifies digital content including generating material selections and sub-material selections. The multi-scale selection system 106 provides the digital content to the third-party system(s) 120.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 116. As another example, the environment 100 includes a third-party server comprising a content server and/or a data collection server.

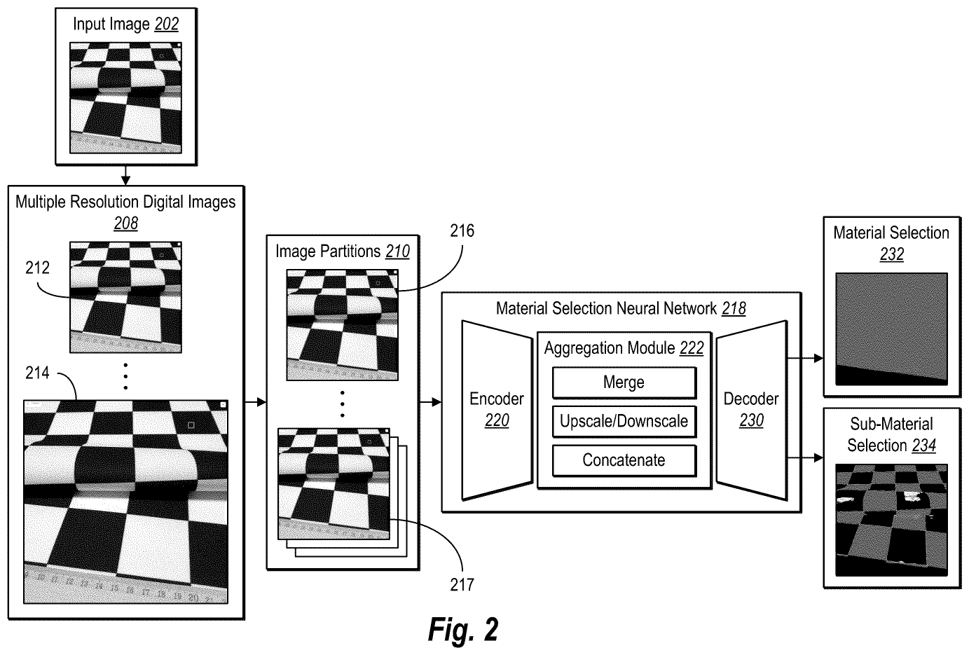

As previously mentioned, in one or more embodiments, the multi-scale selection system 106 generates hierarchical selections for materials displayed within digital images. For instance, FIG. 2 illustrates an example overview of generating a material selection and a sub-material selection for a location in a digital image in accordance with one or more embodiments. Additional detail regarding the various acts of FIG. 2 is provided thereafter with reference to subsequent figures.

As shown in FIG. 2, the multi-scale selection system 106 receives a location (or “query location” or “query pixel”) that corresponds to a material or sub-material in the input image 202. For example, the location includes or refers to a specific pixel or coordinate that acts as a source within the input image 202 that the multi-scale selection system 106 utilizes to determine the material selection 232 or sub-material selection 234 at the location as described herein. In one or more implementations, the multi-scale selection system 106 receives the location via user input. For example, the user clicks, hovers over, taps, or otherwise selects the location.

As used herein the term material selection 232 includes or refers to a selection of pixels of the digital image comprising a material portrayed in the digital image at the query location. As used herein, the term material selection 232 includes the selection of pixels within the input image 202 representing a material such as a primary physical substance or surface property that defines the overall appearance, texture, and behavior of an object, such as wood, metal, fabric, or glass. A material selection 232 includes the selection of a material based on characteristics such as color, roughness, and reflectance that are consistent across the entire material.

Furthermore, as used herein, the term sub-material selection 234 includes or refers to a selection of pixels of the digital image comprising a sub-material portrayed in the digital image at the query location. For example, the sub-material selection 234 includes a selection of pixels within the input image 202 that represent distinctions or localized variations within a material, such as patterns, textures, or regions with differing properties. Examples of sub-materials of the sub-material selection 234 include painted stripes on a wooden table or different types of fabric in a material. In one or more embodiments, a sub-material selection 234 comprises a subset of pixels included in a material selection 232.

As shown in FIG. 2, to generate a material selection 232 and a sub-material selection 23, the multi-scale selection system 106 generates multiple resolution digital images 208 from an input image 202. As used herein, the multiple resolution digital images 208 include or refer to representations of the input image at different levels of resolution, where each representation has a distinct level of detail and pixel density. For example, the multi-scale selection system 106 generates the multiple resolution digital images 208 by scaling the input image 202 to different resolutions, enabling the system to capture both global features and fine-grained details. As shown, generating the multiple resolution digital images 208 includes downscaling the input image 202 to generate the digital image 212 and/or upscaling the input image 202 to generate the digital image 214. In certain embodiments, the multi-scale selection system 106 generates the lowest resolution digital image for the multiple resolution digital images 208 at H×W.

As also shown, the multi-scale selection system 106 generates image partitions 210 from the multiple resolution digital images 208 by partitioning the multiple resolution digital images 208 into non-overlapping image patches. For example, as used herein, the image partitions 210 include or refer to a subset of pixels extracted from a digital image, where each patch represents an independent localized region of the image. In some cases, the image partitions 210 include non-overlapping patches of the same size (H×W) generated from the multiple resolution digital images 208 (e.g., image partitions 217). Alternatively, the patches overlap by a threshold number of pixels. In some cases, for the lowest resolution digital image of the multiple resolution digital images 208, the multi-scale selection system 106 treats the digital image as a single, unified image patch of size H×W (e.g., image partition 216).

As illustrated in FIG. 2, the multi-scale selection system 106 provides the image partitions 210 to a material detection neural network 218. As used herein, a neural network includes or refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model.

In one or more embodiments, the multi-scale selection system 106 utilizes a self-supervised vision transformer to implement the encoder 220 of the material detection neural network 218. For example, the multi-scale selection system 106 utilizes a self-supervised learning Vision Transformer (ViT) to iteratively refine an understanding of image features without requiring labeled data. In some cases, the multi-scale selection system 106 utilizes a pre-trained self-supervised vision transformer such as DINOv2 or HERA to implement the encoder 220 (e.g., a fixed feature extractor) to compute a patch-level representation of the multiple resolution digital images 208.

As further illustrated in FIG. 2, the multi-scale selection system 106 provides the image partitions 210 to the encoder 220 of the material detection neural network 218. In some embodiments, the multi-scale selection system 106 generates multi-scale image features for the image partitions 210 utilizing the encoder 220. For example, multi-scale image features include or refer to features generated by the encoder 220 for a single input (e.g., an image partition) using multiple scales. In one or more embodiments, to generate the multi-scale image features, the encoder 220 generates local and global features for each of the image partitions 210 using a series of transformer blocks. In some cases, encoder 220 combines the local and global features for each of the transformer blocks to generate combined features. The encoder 220 further utilizes upscaling operators to process the combined features to generate the multi-scale image features for each of the image partitions 210 at different scales.

From the multi-scale image features, the multi-scale selection system 106 generates multi-scale aggregated features utilizing an aggregation module 222. As used herein, multi-scale aggregated features include or refer to features generated by aggregating the multi-scale features generated for the image partitions 210. In some cases, the aggregation module 222 performs operations to merge, upscale, downscale, and/or concatenate the multi-scale image features to generate the multi-scale aggregated features. For example, for each resolution of the multiple resolution digital images 208 the aggregation module 222 performs operations to merge, upscale, downscale, and/or concatenate the multi-scale image features at each scale generated from the transformer blocks of the encoder 220 to generate the multi-scale aggregated features.

In one or more embodiments, the multi-scale selection system 106 utilizes the decoder 230 of the material detection neural network 218 to generate the material selection 232 and the sub-material selection 234 from the aggregated multi-scale image features. In some cases, the multi-scale selection system 106 utilizes the decoder 230 to map the aggregated multi-scale image features into the spatial domain utilizing cross-similarity feature weighting on the multi-scale aggregated features. For example, the decoder 230 utilizes cross-similarity feature weighting to generate a material similarity score (which represents the likelihood that pixels of the digital image correspond to a material portrayed in the digital image) and a sub-material similarity score (which represents the likelihood that pixels of the digital image correspond to a sub-material portrayed in the digital image). Based on the material matching score satisfying a material matching threshold, embodiments of the multi-scale selection system 106 select pixels of the input image 202 for the material selection 232. Similarly, based on the sub-material matching score satisfying a sub-material matching threshold, embodiments of the multi-scale selection system 106 select pixels of the input image 202 for the sub-material selection 234.

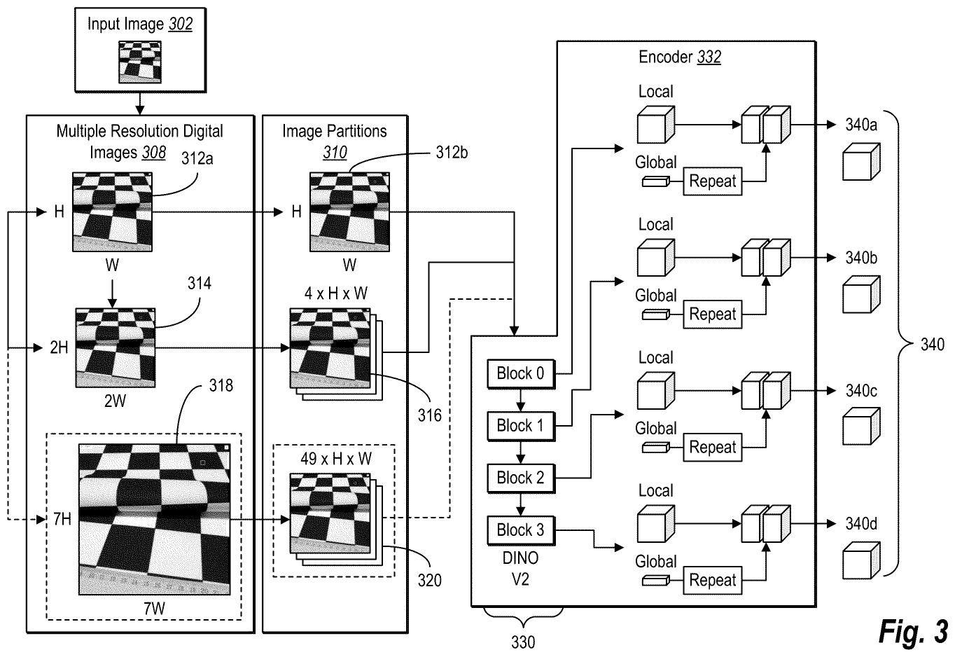

As described above, the multi-scale selection system 106 quantifies how similar materials at each pixel of a digital image are to the material at the location of a query location and/or query pixel based on multi-scale image features. Similarly, the multi-scale selection system 106 quantifies how similar sub-materials at each pixel of a digital image are to the sub-material at the location of a query location and/or query pixel based on multi-scale image features. FIG. 3 illustrates an example of utilizing an encoder of a material detection neural network to generate multi-scale features for multiple resolutions of a digital image in accordance with one or more embodiments.

As shown in FIG. 3, in certain embodiments, the multi-scale selection system 106 generates multiple resolution digital images 308 from an input image 302. In certain embodiments, the multi-scale selection system 106 generates one or more of the multiple resolution digital images 308 by upscaling the input image 302. For example, for the input image 302 at an initial resolution H×W, the multi-scale selection system 106 utilizes the input image 302 as the digital image 312a (where the input image 202 is at the resolution for the encoder 332 input). Furthermore, the multi-scale selection system 106 generates one or more of the multiple resolution digital images 308 by upscaling the input image 302 to additional resolutions to generate the digital image 314 (e.g., 2H×2W), the digital image 318 (e.g., 7H×7W), and/or additional digital images (e.g., 4H×4W, 8H×8W, etc.)

In some cases, the multi-scale selection system 106 generates one or more of the multiple resolution digital images 208 by downscaling the input image 202. For example, for the input image 302 at an initial resolution 7H×7W, the multi-scale selection system 106 utilizes the input image 302 as the digital image 318 (where the input image 202 is at the resolution for the encoder 332 input). Furthermore, the multi-scale selection system 106 generates one or more of the multiple resolution digital images 308 by downscaling the input image 302 to additional resolutions to generate the digital image 314 (e.g., 2H×2W), the digital image 312a (e.g., H×W), and/or additional digital images (e.g., 3H×3W, 4H×4W, etc.).

As further shown in FIG. 3, the multi-scale selection system 106 generates the image partitions 310 from the multiple resolution digital images 308. In one or more embodiments, the multi-scale selection system 106 generates the image partitions 310 at a uniform size (e.g., H×W) from the multiple resolution digital images 308. In some cases, the multi-scale selection system 106 utilizes the digital image 312a at size H×W as an image partition 312b without alteration (e.g., 1×H×W). As also shown, the multi-scale selection system 106 partitions the digital image 314 by splitting the digital image 314 into equally sized, non-overlapping image partitions to generate the image partitions 316 (e.g., 4×H×W). In addition, the multi-scale selection system 106 partitions the digital image 318 by splitting the digital image 318 into equally sized, non-overlapping image partitions to generate the image partitions 320 (e.g., 49×H×W). In certain embodiments, the multi-scale selection system 106 utilizes a resolution for the image partition 312b, the image partitions 316, and the image partitions 320 based on an input resolution of the encoder 332.

As further shown in FIG. 3, the multi-scale selection system 106 utilizes the encoder 332 of a material selection neural network to generate the multi-scale image features 340 from the image partitions 310. As shown, the encoder 332 generates the multi-scale image features 340 utilizing both global features and local features. In some cases, the multi-scale selection system 106 utilizes a self-supervised vision transformer as the encoder 332 to determine the multi-scale image features 340 for the image partitions 310.

For example, the multi-scale selection system 106 utilizes the encoder 332 to process each of the image partitions 310 as an encoder input image. For each encoder input image, the encoder 332 splits the encoder input image into non-overlapping patches. The encoder 332 processes the non-overlapping patches through a series of transformer attention blocks 330 (e.g., Block 0, Block 1, Block 2, Block 3). In some embodiments, the multi-scale selection system 106 utilizes a subset of the transformer attention blocks available to the encoder 332 (e.g., a subset of the 12 available transformer attention blocks at indexes 2, 5, 8, 11 from a DINOv2 encoder). As shown, the encoder 332 encodes a combination of local patch information and global patch information using the transformer attention blocks 330. In certain embodiments, the multi-scale selection system 106 denotes the local patch information as a local spatial feature tensor φᵢ the global patch information as a global spatial feature tensor Ψᵢ utilizing a representation such as:

$${ϕ}_{i} ∈ {IR}^{d \cdot \frac{h}{8} \cdot \frac{w}{8}}$$

$${ψ}_{i} ∈ {IR}^{d}$$

where h, w∈IN² are the input spatial dimensions, d=768 is the feature dimension, and i∈{1, . . . , 4} indexes the transformer attention blocks 330.

Furthermore, in certain embodiments, the encoder 332 aggregates the local spatial feature tensor φᵢ and the global spatial feature tensor Ψᵢ for the transformer attention blocks 330. For example, the encoder 332 replicates the global spatial feature tensor Ψᵢ spatially and concatenates the global spatial feature tensor Ψᵢ with the local spatial feature tensor φᵢ. The encoder 332 processes the aggregated local spatial feature tensor φᵢ and global spatial feature tensor Ψᵢ utilizing a convolutional network. Furthermore, the encoder 332 applies a bilinear up-scaling factor (e.g., an up-scaling factor sᵢ for each of the transformer attention blocks 330) to obtain the multi-scale image features 340 for the encoder input image, utilizing a representation such as:

$${f}_{i} ( {ϕ}_{i} , {ψ}_{i} ) ∈ {IR}^{{d}^{′} \times {s}_{i} \frac{h}{8} \times {s}_{i} \frac{w}{8}}$$

with d′=256. In some embodiments, the multi-scale selection system 106 utilizes bilinear up-scaling factors such as: s₀=4 for Block 0, s₁=2 for Block 1, s₂=1 for Block 3, s₃=1 for Block 4, such that earlier feature blocks are weighted, or up-sampled, more.

To illustrate, the encoder 332 generates the multi-scale image features 340 for each of the image partitions 310. For example, for the image partition 312b and using factors of s₀=4 for Block 0, s₁=2 for Block 1, s₂=1 for Block 3, s₃=1 for Block 4, the encoder 332 generates the multi-scale image features 340a at a scale of ½ of the image partition 312b, the multi-scale image features 340b at a scale of ¼ of the image partition 312b, the multi-scale image features 340c at a scale of ⅛ of the image partition 312b, and the multi-scale image features 340d at a scale of ⅛ of the image partition 312b. For example, for each of the image partitions of the image partitions 316 and using factors of s₀=4 for Block 0, s₁=2 for Block 1, s₂=1 for Block 3, s₃=1 for Block 4, the encoder 332 generates the multi-scale image features 340a at a scale of ½ of the image partition, the multi-scale image features 340b at a scale of ¼ of the image partition, the multi-scale image features 340c at a scale of ⅛ of the image partition, and the multi-scale image features 340d at a scale of ⅛ of the image partition. Similarly, the encoder 332 generates sets of the multi-scale image features 340 for each of the image partition of the image partitions 320.

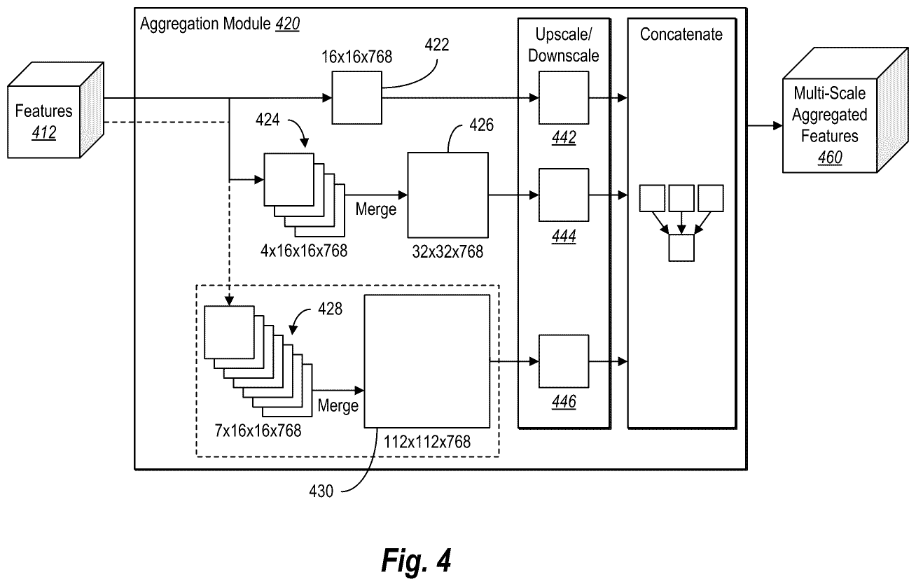

To further refine the multi-scale image features, the multi-scale selection system 106 generates multi-scale aggregated features from sets of the multi-scale image features generated by the encoder of a material selection neural network. FIG. 4 illustrates an example of utilizing an aggregation module of a material detection neural network to generate multi-scale aggregated features by aggregating sets of multi-scale image features in accordance with one or more embodiments.

To illustrate, as described above in relation to FIG. 3, the multi-scale selection system 106 utilizes an encoder 332 to generate the multi-scale image features 412 for a digital image. For example, the aggregation module compiles sets of the multi-scale image features 412 for each of the multi-scale image features 340a, the multi-scale image features 340b, the multi-scale image features 340c, and the multi-scale image features 340d as described in relation to FIG. 4.

To illustrate, for the multi-scale image features 340a, the multi-scale selection system 106 compiles multi-scale image features 422 for a first resolution as the multi-scale image features 340a generated for the image partition 312b (e.g., a set of one). In addition, the multi-scale selection system 106 compiles a set of multi-scale image features 424 for a second resolution from the multi-scale image features 340a generated for the image partitions 316. In some embodiments, the multi-scale selection system 106 compiles a set of multi-scale image features 428 for a third resolution from the multi-scale image features 340a generated for the image partitions 320 (and/or additional partitions at additional resolutions). In this way, embodiments of the multi-scale selection system 106 generate the multi-scale image features 412 which represent materials and sub-materials within the digital image at multiple resolutions.

As further shown in FIG. 4, the aggregation module 420 merges the sets of the multi-scale image features. For example, the aggregation module 420 merges the multi-scale image features by arranging and/or spatially aligning the multi-scale image features into respective spatial positions corresponding to a feature map for the digital image. In one or more embodiments, the multi-scale selection system 106 utilizes the multi-scale image features 422 for the digital image at a first resolution (e.g., a set of one). Furthermore, the multi-scale selection system 106 aligns and merges the set of multi-scale image features 424 to obtain the multi-scale image features 426 for the digital image at a second resolution. In some embodiments, the multi-scale selection system 106 aligns and merges the set of multi-scale image features 428 to obtain the multi-scale image features 430 for the digital image at a third resolution. Similarly, the multi-scale selection system 106 aligns and merges one or more additional multi-scale image features to obtain multi-scale image features for the digital image at one or more additional resolutions.

After merging the sets of multi-scale image features, in certain embodiments, the aggregation module 222 the aggregation module 420 upscales and/or downscales the multi-scale image features. In some cases, the multi-scale selection system 106 utilizes the aggregation module 420 to upscale the multi-scale image features generated from lower resolutions match the resolution of multi-scale image features generated from higher resolutions. For example, the aggregation module 420 upscales the multi-scale image features 422 to align with the resolution of the multi-scale image features 426. In some cases, the multi-scale selection system 106 utilizes the aggregation module 222 to downscale multi-scale image features generated from higher resolutions match the multi-scale image features generated from lower resolutions. For example, the aggregation module 420 downscales the multi-scale image features 426 to align with the resolution of the multi-scale image features 422.

Similarly, in certain embodiments, the aggregation module 420 upscales (and/or downscales) the multi-scale image features for three or more image resolutions. For example, the aggregation module 420 upscales the multi-scale image features 422 and the multi-scale image features 426 (and any additional multi-scale image features) to align with the resolution of the multi-scale image features 430. In some cases, the aggregation module 420 downscales the multi-scale image features 430 and the multi-scale image features 426 (and any additional multi-scale image features) to align with the resolution of the multi-scale image features 422.

As also shown in FIG. 4, after upscaling/downscaling the multi-scale image features, the aggregation module 420 concatenates the multi-scale image features along a feature dimension to generate the multi-scale aggregated features 460. To illustrate, the aggregation module 420 concatenates the multi-scale image features 442, the multi-scale image features 444, and the multi-scale image features 446 (and any additional multi-scale image features) along a feature dimension to generate the multi-scale aggregated features 460. In certain embodiments, by aggregating the multi-scale image features from multiple input resolutions as described, the aggregation module 420 generates feature tensors with a higher resolution that are more accurate and robust across scales, as represented by the multi-scale aggregated features 460.

Notably, as mentioned above, the multi-scale selection system 106 utilizes the aggregation module 420 to generate the multi-scale aggregated features 460 for each of the multi-scale image features 340a, the multi-scale image features 340b, the multi-scale image features 340c, and the multi-scale image features 340d as described in relation to FIG. 4.

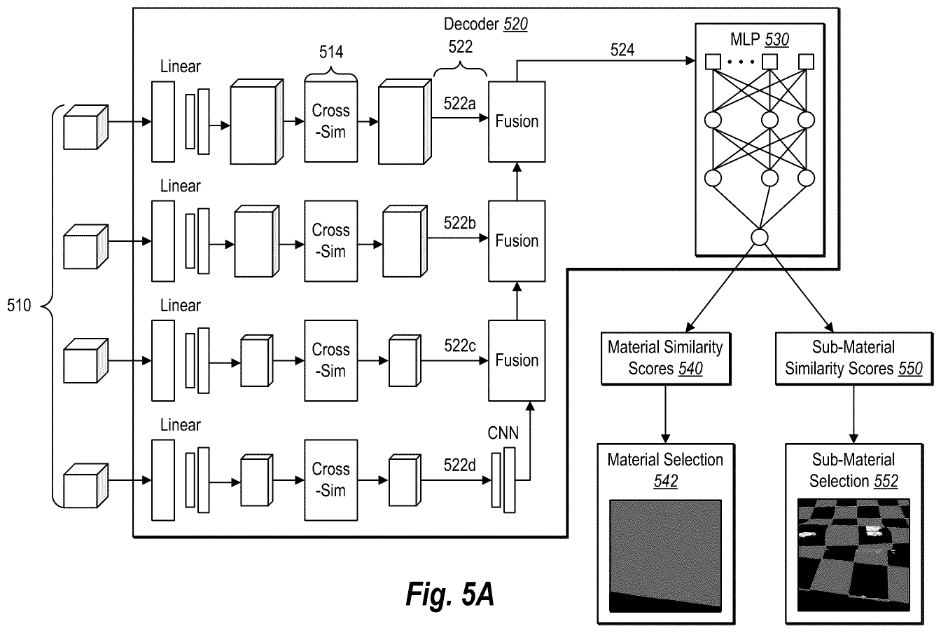

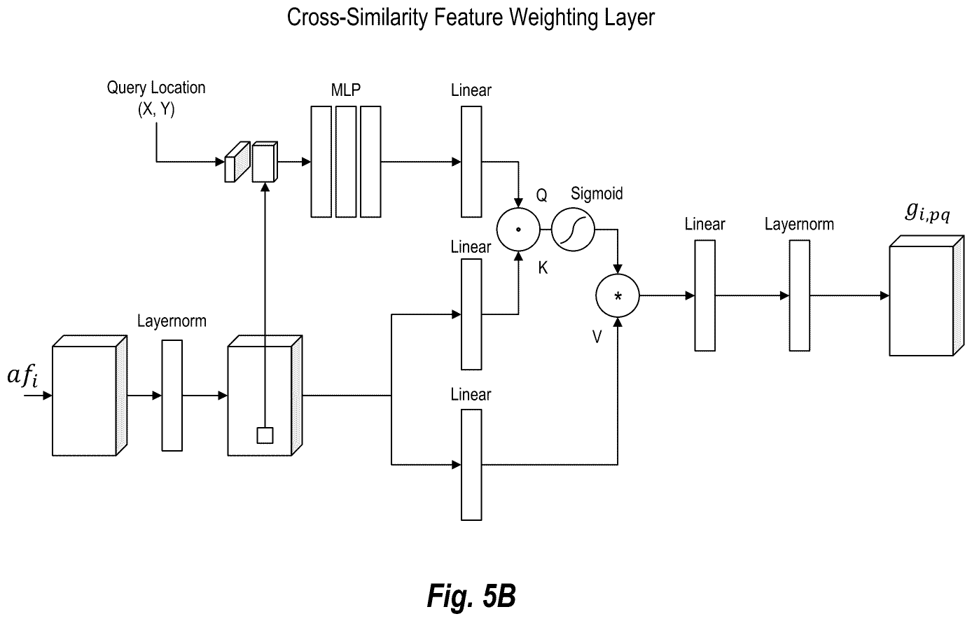

In one or more embodiments, the multi-scale selection system 106 utilizes a decoder to generate a material selection and a sub-material selection for a digital image. FIGS. 5A-5B illustrate an example of utilizing a decoder of a material detection neural network to generate a material selection and a sub-material selection from aggregated multi-scale features in accordance with one or more embodiments.

As shown in FIG. 5A, in one or more embodiments, the multi-scale selection system 106 utilizes a decoder 520 to generate the material selection 542 and the sub-material selection 552. For example, the decoder 520 weights the multi-scale aggregated features 510 generated by an aggregation module such that the multi-scale aggregated features 510 are generalized to additional materials (e.g., materials unseen during training). To generalize the multi-scale aggregated features 510, the multi-scale selection system 106 utilizes the decoder 520 to transform the multi-scale aggregated features 510 into weighted multi-scale aggregated features 522. As shown, utilizing the decoder 520, the multi-scale selection system 106 processes the multi-scale aggregated features 510 at multiple levels, combines the multi-scale aggregated features 510 features with an embedding of the query location using cross-similarity weighting, and fuses the weighted multi-scale aggregated features 522 to generate a fused features 524.

More specifically, as shown in FIG. 5A, the multi-scale selection system 106 utilizes the decoder 520 to convert the multi-scale aggregated features 510 into the weighted multi-scale aggregated features 522. In this way, the multi-scale selection system 106 transforms the multi-scale aggregated features 510 to account for a generalized material and a generalized sub-material at a query location as the weighted multi-scale aggregated features 522. For example, using the weighted multi-scale aggregated features 522, the multi-scale selection system 106 distinguishes between materials and/or sub-materials to identify characteristics relevant to fine-grained differentiation. To illustrate, by identifying subtle differences in material properties (such as texture, reflectance, or patterns) using the weighted multi-scale aggregated features 522, the multi-scale selection system 106 differentiates between materials that share overarching similarities within the same semantic class (e.g., two types of wood or two fabrics).

As mentioned, to determine the weighted multi-scale aggregated features, the multi-scale selection system 106 utilizes cross-similarity feature weighting layer(s) 514. As shown in FIG. 5B, the multi-scale selection system 106 utilizes the cross-similarity similarity feature weighting layer(s) 514 of the decoder 520 to modulate the features at a pixel p∈[0, 1]² of the input image using a location-dependent weight (e.g., location-dependent weight of a pixel p at each resolution I). As shown, the cross-similarity feature weighting layer(s) 514 determines the values of K and V by processing the multi-scale aggregated features 510 (e.g., afᵢ) with two linear layers utilizing normalized coordinates. To obtain spatial information from the multi-scale aggregated features 510 relative to the query location, the cross-similarity feature weighting layer(s) 514 determine a value for Q. Furthermore, the cross-similarity feature weighting layer(s) 514 determine Q by concatenating an embedding extracted from the from the multi-scale aggregated features 510 at the query location with the query location coordinates. In addition, the cross-similarity feature weighting layer(s) 514 feeds the concatenated embedding to an MLP to obtain Q. In one or more embodiments, the multi-scale selection system 106 determines a location-dependent weight w of pixel p at each resolution i as given by:

$${w}_{i , p q} = σ ( \frac{{Q}^{1} K}{\sqrt{d}} ) ∈ {[ 0 , 1 ]}^{{s}_{i} \frac{h}{8} \times {s}_{i} \frac{w}{8}}$$

where σ is a sigmoid activation. Given the weight w_{i.pq}, the multi-scale selection system 106 computes the weighted multi-scale aggregated features 522 as gᵢ such as given by:

$${g}_{i , pq} = {w}_{i , p q} \cdot V$$

Turning back to FIG. 5A, the decoder 520 utilizes the cross-similarity feature weighting layer(s) 514 as described in relation to FIG. 5B, to generate the weighted multi-scale aggregated features 522 for a material and a sub-material at a query location (e.g., for a pixel q∈[_{0, 1}]²). In certain embodiments, the multi-scale selection system 106 fuses the weighted multi-scale features gᵢ (e.g., weighted multi-scale features 522d, weighted multi-scale features 522c, weighted multi-scale features 522b, and weighted multi-scale features 522a) to generate the fused features 524. As shown, the multi-scale selection system 106 progressively fuses the weighted multi-scale aggregated features 522 from course features (e.g., the weighted multi-scale features 522d) to fine features (e.g., the weighted multi-scale features 522a). In some cases, the multi-scale selection system 106 utilizes a residual network followed by 2x bilinear up-sampling between each consecutive fusion to generate a multi-dimensional feature vector for the fused features 524.

In one or more embodiments, the multi-scale selection system 106 provides the fused features 524 to the MLP 530 to generate the material selection 542 and the sub-material selection 552. For example, the multi-scale selection system 106 utilizes a MLP 530, a multilayer perceptron with a material selection head with an output of two channels, to generate the material similarity scores 540 and the sub-material similarity scores 550. In some cases, the decoder 520 utilizes the first channel (“SVBRDF channel”) of the material selection head of the MLP 530 to generate the material similarity scores 540 based on spatially varying bidirectional reflectance distribution (“SVBRDF”). Furthermore, the decoder 520 utilizes the second channel (“BRDF channel”) of the material selection head of the MLP 530 to generate the material similarity scores 540 based on bidirectional reflectance distribution (“BRDF”). The multi-scale selection system 106 determines the outputs of the SVBRDF channel and the BRDF channel independently, generating the material similarity scores 540 utilizing the SVBRDF channel and the sub-material similarity scores 550 utilizing the BRDF channel.

For instance, the MLP 530 utilizes a shared material selection head with the SVBRDF channel that handles the selection of materials at the texture level using SVBRDF. For example, using the SVBRDF channel, the MLP 530 generates the material similarity scores 540 from the fused features 524 that correspond to texture-level properties such as reflectance, surface geometry, roughness, specularity, and metallicity. The multi-scale selection system 106 utilizes the SVBRDF channel to handle varying textures, colors, and surface properties across materials, improving the accuracy of pixel selection. Utilizing the SVBRDF channel, the MLP 530 utilizes the fused features 524 to determine the (per-pixel) material similarity score 540 indicating the likelihood of the pixel belonging to a specific material category (e.g., such as wood, metal, or fabric).

Furthermore, in one or more embodiments, the MLP 530 utilizes the material selection head with the BRDF channel to identify sub-materials within the material using BRDF. For example, using the BRDF channel, the MLP 530 refines the material selection by identifying sub-materials or patterns within the materials (e.g., stripes on a fabric, or variations on a painted surface). Using the SVBRDF channel, the MLP 530 generates the material similarity scores 540 from the fused features 524 that correspond to texture-level properties such as diffuse reflectance, specular reflectance, glossiness, and anisotropy (direction-dependent reflections). Using the BRDF channel, the MLP 530 utilizes the fused features 524 to determine the (per-pixel) sub-material similarity score 550 indicating the likelihood of the pixel belonging to a specific sub-material category.

In one or more embodiments, the multi-scale selection system 106 generates the material selection 542 from the material similarity scores 540. For example, the multi-scale selection system 106 generates the material selection 542 by comparing the material similarity scores 540 for the pixels of the digital image to a material matching threshold. In certain embodiments, the multi-scale selection system 106 generates a binary mask for the material selection 542, such that the binary mask portrays the pixels of the digital image that meet the material matching threshold using a first value and portrays the other pixels of the digital image using a second value. In some embodiments, the multi-scale selection system 106 generates an overlay for the material selection 542, such that the overly visually distinguishes the pixels of the digital image comprising the material portrayed in the digital image (and satisfy the material matching threshold) from other pixels of the digital image (e.g., utilizing a distinguishing color or pattern).

In one or more embodiments, the multi-scale selection system 106 generates the sub-material selection 552 from the sub-material similarity scores 550. For example, the multi-scale selection system 106 generates the sub-material selection 552 by comparing the sub-material similarity scores 550 for the pixels of the digital image to a sub-material matching threshold. In certain embodiments, the multi-scale selection system 106 generates a binary mask for the sub-material selection 552, such that the binary mask portrays the pixels of the digital image that meet the sub-material matching threshold using a first value and portrays the other pixels of the digital image using a second value. In some embodiments, the multi-scale selection system 106 generates an overlay for the sub-material selection 552, such that the overly visually distinguishes the pixels of the digital image comprising the sub-material portrayed in the digital image (and satisfy the sub-material matching threshold) from other pixels of the digital image (e.g., utilizing a distinguishing color or pattern).

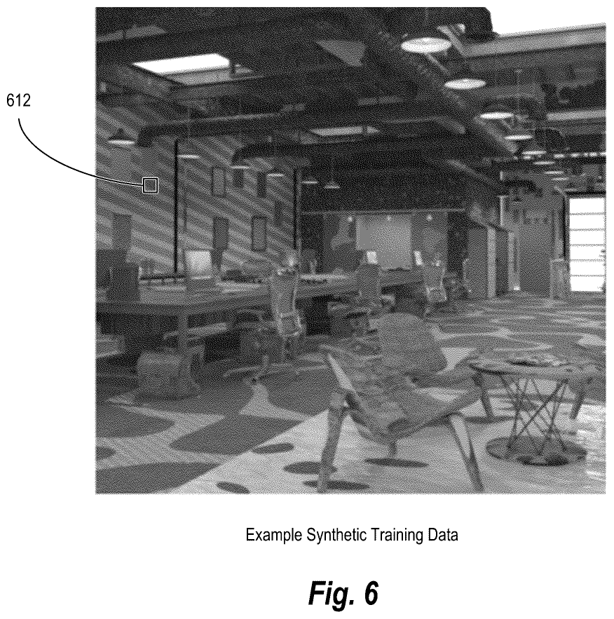

In one or more embodiments, the multi-scale selection system 106 trains a material detection neural network utilizing training images that contain hierarchical materials (e.g., materials composed of sub-materials that are visually distinct from each other). FIG. 6 illustrates an example of training data the multi-scale selection system 106 uses to train a material detection neural network to generate a material selection and a sub-material selection in accordance with one or more embodiments.

As shown in FIG. 6, in one or more embodiments, the multi-scale selection system 106 utilizes a training dataset of training images that contain hierarchical materials to train the material detection neural network. In some cases, the multi-scale selection system 106 utilizes a training dataset that includes synthetic images that contain hierarchical materials. In some cases, the multi-scale selection system 106 utilizes a dataset of 800K+ synthetic images of scenes with random material assignments including hierarchical material annotations (e.g., ground truth annotations) at two different levels: SVBRDF (e.g., such as a patterned fabric at query location 612) and BRDF (e.g., such as the stripes of the patterned fabric at query location 612). In certain embodiments, the multi-scale selection system 106 generates random material assignments for the dataset by randomly sampling and replacing materials within the training images. In addition, in some embodiments, the multi-scale selection system 106 varies light sources and viewing angles to increase the diversity of the training dataset.

In one or more embodiments, the multi-scale selection system 106 utilizes videos to generate the training dataset that contains hierarchical materials. For example, the multi-scale selection system 106 utilizes videos to increase the diversity of the training dataset by using sequences of frames to display the same material and/or sub-material under varying conditions. To illustrate, the multi-scale selection system 106 utilizes videos to provide a training dataset that includes a variety of lighting conditions (e.g., shadows, highlights), viewpoints (e.g., movement, zoom level), and context (object interaction, occlusion) for the material and/or the sub-materials.

In certain embodiments, the multi-scale selection system 106 utilizes a binary cross-entropy loss to train the material detection neural network using the training dataset. For example, the multi-scale selection system 106 utilizes a binary cross-entropy loss function to measure whether the predicted material selection matches the ground truth material (within a material matching threshold) in a training image based on a query location. In some cases, the multi-scale selection system 106 utilizes a binary cross-entropy loss function to measure whether the predicted sub-material selection matches the ground truth sub-material (within a sub-material matching threshold) in the training image based on the query location. In some cases, the multi-scale selection system 106 utilizes a cross-entropy loss function such as the following to determine the cross-entropy loss:

$${L}_{C r ossEntropy} = - \frac{1}{N} {\sum }_{n = 1}^{N} {\sum }_{c = 1}^{C} {y}_{i , c} log {\hat{y}}_{i , c}$$

### Where:

N=total number of pixels
C=number of material or sub-material categories
Y_{i,c}=ground truth one-hot vector for pixel i and class c
ŷ_{i,c}=predicted probability for pixel i and class c

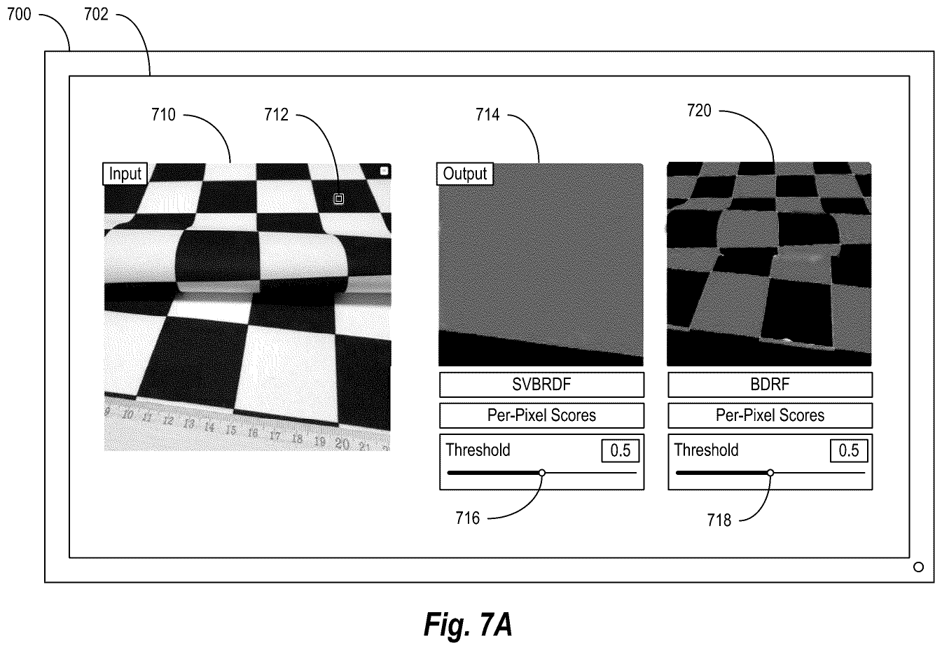

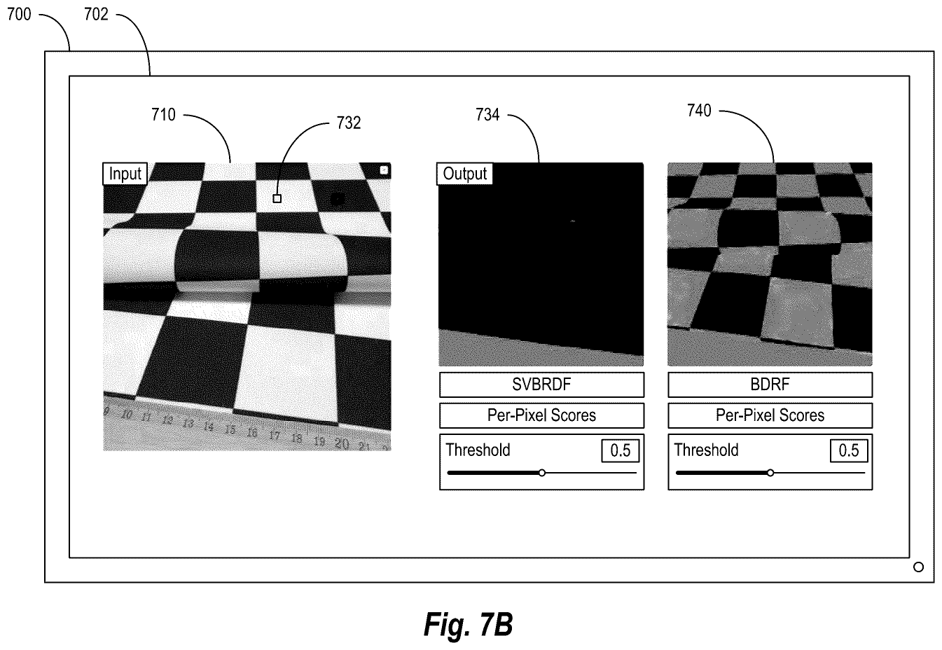

As mentioned, the multi-scale selection system 106 provides a graphical user interface to generate a material selection and/or a sub-material selection based on a selection of a query location in a digital image. FIGS. 7A-7B illustrate an example of the multi-scale selection system 106 utilizing a graphical user interface to display a material selection and a sub-material selection for a location in a digital image in accordance with one or more embodiments.

For instance, as shown in FIG. 7A, the multi-scale selection system 106 provides digital content for display on a graphical user interface 702 of a client device 700. In particular, the multi-scale selection system 106 generates and provides, for display on the graphical user interface 702, a material selection 714 and/or a sub-material selection 720 based on the selection of a location 712 in a digital image 710 as described in relation to FIGS. 1-6. For example, the multi-scale selection system 106 provides, for display on the graphical user interface 702, the material selection 714 corresponding to the material of the checkered cloth and the sub-material selection 720 corresponding to the sub-material of the black squares within the checkered cloth.

As shown in FIG. 7A, in certain embodiments, the multi-scale selection system 106 provides the material selection 714 for display on the graphical user interface 702 utilizing a binary mask. For example, the multi-scale selection system 106 provides the material selection 714 based on material similarity scores generated for each pixel of the digital image 710 by the material detection neural network utilizing the SVBRDF channel of a material selection head. By selecting the pixels with a material similarity score that satisfies a material matching threshold 716, the multi-scale selection system 106 selects pixels within the digital image 710 that correspond to a material (e.g., the checkered cloth) displayed at the location 712. As shown, the multi-scale selection system 106 differentiates between the material at the location 712 and other materials (e.g., the ruler) of the digital image 710. As also shown, the multi-scale selection system 106 displays the material selection 714 using a binary mask which includes a binary representation of the material at the location 712 using a first value and all other materials of the digital image 710 using a second value.

Similarly, in certain embodiments, the multi-scale selection system 106 provides the sub-material selection 720 for display on the graphical user interface 702 utilizing a binary mask. For example, the multi-scale selection system 106 provides the sub-material selection 720 based on sub-material similarity scores generated for each pixel of the digital image 710 by the material detection neural network utilizing the BRDF channel of the material selection head. By selecting the pixels with a sub-material similarity score that satisfies a sub-material matching threshold 718, the multi-scale selection system 106 selects pixels within the digital image 710 that correspond to a sub-material (e.g., the dark squares of the checkered cloth) displayed at the location 712. As shown, the multi-scale selection system 106 differentiates between the sub-material at the location 712 and other sub-materials (e.g., the white squares of the checkered cloth) of the digital image 710. As shown, the multi-scale selection system 106 displays the sub-material selection 720 using a binary mask which includes a binary representation of the sub-material at the location 712 using a first value and all other materials and sub-materials of the digital image 710 using a second value.

Turning to FIG. 7B, in certain embodiments, the multi-scale selection system 106 modifies the material selection and/or sub-material selection based on a change to the query location. For example, the multi-scale selection system 106 provides a material selection 734 and/or a sub-material selection 740 for display based on a selection of a location 732 in the digital image 710. In particular, based on a selection of a new location (e.g., the location 732) within the digital image 710, the multi-scale selection system 106 generates the material selection 734 and/or the sub-material selection 740 for display on the graphical user interface 702.

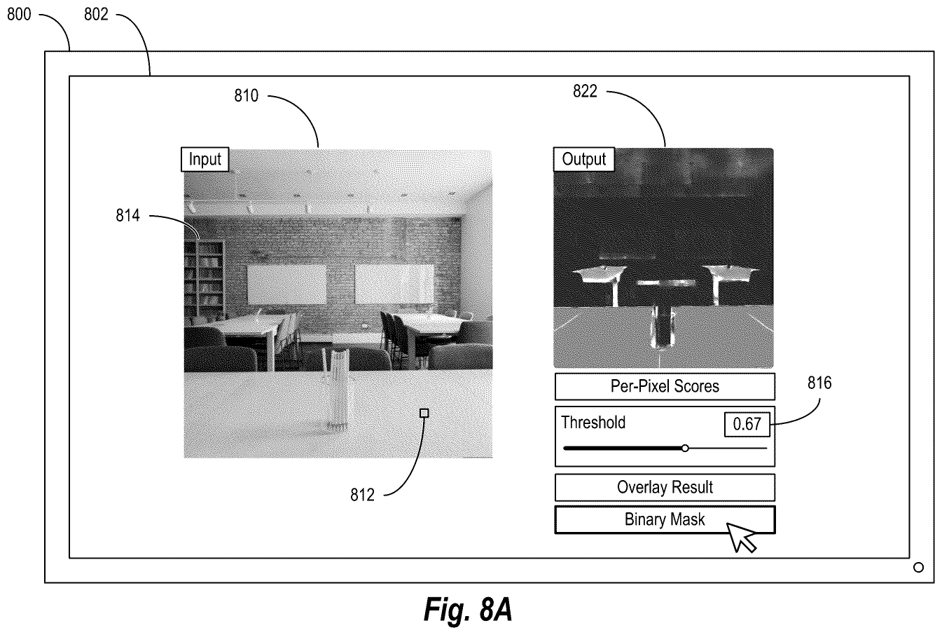

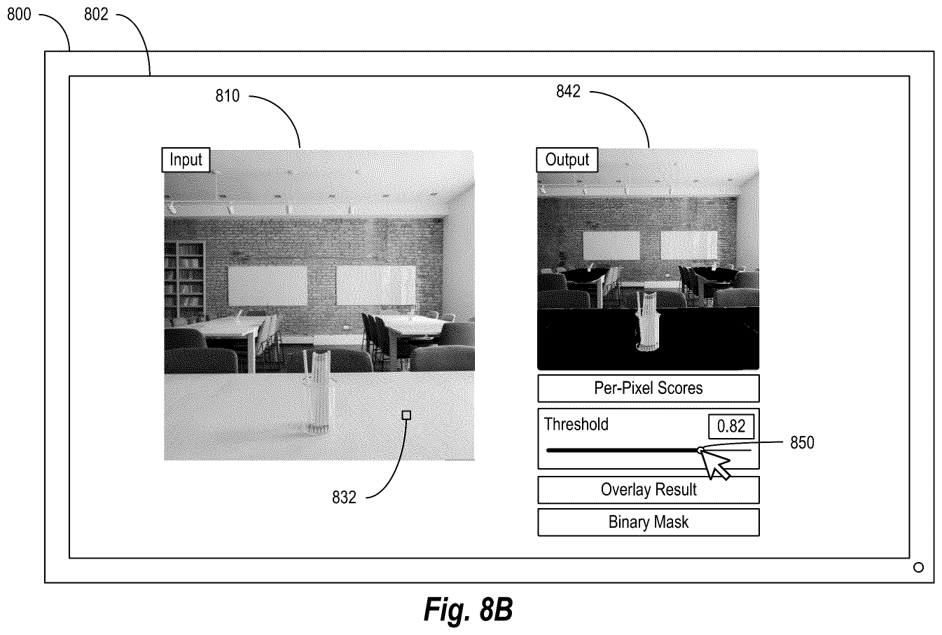

In one or more embodiments, the multi-scale selection system 106 generates a material selection and/or a sub-material selection that includes multiple objects within a digital image based on a selection of a query location. FIGS. 8A-8B illustrate an example of the multi-scale selection system utilizing a graphical user interface to display a material selection that includes multiple objects utilizing an overlay and/or a binary mask in in accordance with one or more embodiments

For instance, as shown in FIG. 8A, the multi-scale selection system 106 provides digital content for display on a graphical user interface 802 of a client device 800. In particular, the multi-scale selection system 106 provides, based on a selection of a location 812 in a digital image 810 on the graphical user interface 802, an indication of a material selection 822. As shown, the multi-scale selection system 106 displays the material selection 822 as a binary mask which represents pixels of the objects containing the material at the location 812 (e.g., chairs and table made of the same type of wood). Notably, the multi-scale selection system 106 distinguishes between the material at the location 812 and other materials in the digital image 810 (including materials of the same semantic class). For example, the multi-scale selection system 106 distinguishes between the material represented by the type of wood of the table at the location 812 and the material represented by type of wood of a bookshelf at location 814.

Furthermore, in certain embodiments, provides an interface to select between a material selection and/or a sub-material selection for the material at the location 812 in the digital image 810. For example, as shown in FIG. 8A, in some embodiments, where the digital image 810 displays a non-hierarchical material at the location 812 (e.g., the material does not include a sub-material), the multi-scale selection system 106 generates and displays an indication of the material selection 822 (e.g., via a binary mask and/or overlay). Similarly, in cases where the user of the graphical user interface 802 selects an option to display a selection of the material (and not the sub-material), the multi-scale selection system 106 generates and displays an indication of the material selection 822. In some cases, where the user of the graphical user interface 802 selects an option to display a selection of the sub-material, the multi-scale selection system 106 displays an indication of the sub-material selection.

In some embodiments, where the digital image 810 displays a non-hierarchical material at the location 812, the multi-scale selection system 106 provides the material selection 822 based on the material similarity scores generated for each pixel of the digital image 810 by the material detection neural network utilizing the SVBRDF channel of the material selection head (as described above). In certain embodiments, the multi-scale selection system 106 provides the material selection 822 based on material similarity scores generated for each pixel of the digital image 810 by the material detection neural network utilizing the SVBRDF channel of the material selection head in combination with the BRDF channel of the material selection head. In some cases, the multi-scale selection system 106 generates the same values for the SVBRDF channel of the material selection head and the BRDF channel of the material selection head for non-hierarchical materials.

By selecting the pixels with a material similarity score that satisfies a material matching threshold (e.g., threshold 816), the multi-scale selection system 106 selects the pixels (e.g., the wood of three tables) within the digital image 810 that correspond to a material displayed at the location 812 (e.g., a pixel of a table). As described above, the multi-scale selection system 106 differentiates between the material at the location 812 and other materials (e.g., the wall, chairs, floor, and bookshelf) of the digital image 810. As shown, the multi-scale selection system 106 displays the material selection 822 using a binary mask which includes a binary representation of the material at the location 812 using a first value and all other materials of the digital image 810 using a second value.

As further shown in FIG. 8B, some embodiments of the multi-scale selection system 106 display the material selection 842 utilizing an overlay. In particular, the multi-scale selection system 106 selects pixels for a material display at the location 832 to display for the material selection 842 based on the material selection threshold 850. As shown, the multi-scale selection system 106 displays the material selection 842 such that the overly visually distinguishes the pixels of the digital image comprising the material portrayed in the digital image (and satisfy the material matching threshold) from other pixels of the digital image (e.g., utilizing a distinguishing color or pattern).

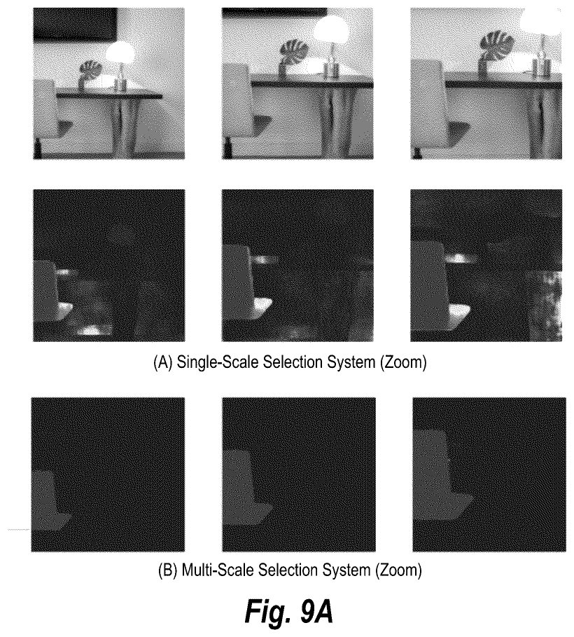

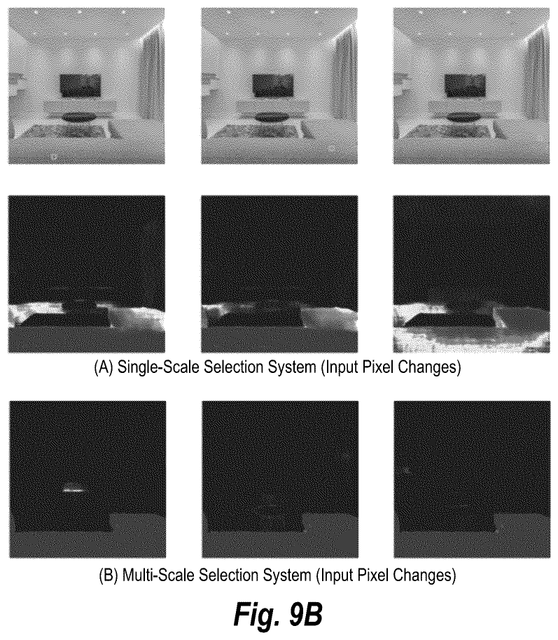

As mentioned, the multi-scale selection system 106 provides accurate selections of pixels within a digital image corresponding to a material at a query location. FIGS. 9A-9B illustrate qualitative comparisons of the accuracy of the multi-scale selection system 106 with the accuracy of existing single-scale selection systems in accordance with one or more embodiments.

As shown in FIG. 9A, the multi-scale selection system 106 provides robust, consistent, and accurate results for selections of pixels corresponding to an object at a query location using a variety of zoom levels. By utilizing multiple resolutions of the input image in combination with an aggregation module, embodiments of the multi-scale selection system 106 more accurately handle variations in object size and appearance caused by changes in zoom levels than existing single-scale selection systems. As shown, the multi-scale selection system 106 ensures that pixel selections remain consistent across zoom levels, displaying similar pixel selections for an object at a lower zoom level (e.g., a coarse resolution) and the same object when zoomed in (e.g., a fine resolution) and avoiding selection discrepancies. Notably, as shown by FIG. 9A, the multi-scale selection system 106 provides noticeable improvements over existing single-scale selection systems.

As shown in FIG. 9B, the multi-scale selection system 106 provides robust, consistent, and accurate results for selections of pixels corresponding to an object for a query location at multiple locations. By utilizing multiple resolutions of the input image in combination with an aggregation module, embodiments of the multi-scale selection system 106 more accurately handle variations in how a material appears at different selection positions based on lighting changes, reflections, shadows, or view angle than existing single-scale selection systems. As shown by the material selections for a variety of query locations, embodiments of the multi-scale selection system 106 more accurately select the pixels of the input image that correspond to the material of the object than existing single-scale selection systems. In particular, the multi-scale selection system 106 provides noticeable improvements over existing single-scale selection systems by utilizing the multi-scale aggregated features generated from multiple image resolutions.

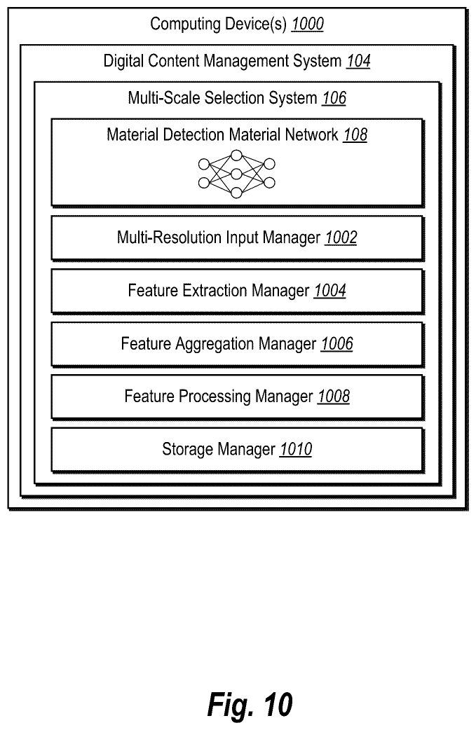

Turning now to FIG. 10, additional detail will now be provided regarding various components and capabilities of the multi-scale selection system 106. In particular, FIG. 10 illustrates the multi-scale selection system 106 implemented by the computing device 1000 (e.g., the server device(s) 102 and/or one of the client device(s) 110 discussed above with reference to FIG. 1). Additionally, the multi-scale selection system 106 is also part of the digital content management system 104. As shown in FIG. 10, the multi-scale selection system 106 includes, but is not limited to, a multi-resolution input manager 1002, a feature extraction manager 1004, a feature aggregation manager 1006, a feature processing manager 1008, and a data storage manager 1010.

As just mentioned, and as illustrated in FIG. 10, the multi-scale selection system 106 includes the multi-resolution input manager 1002. In one or more embodiments, the multi-resolution input manager 1002 manages the generation of encoder inputs for a material detection neural network 108 using multiple resolutions of an input image to generate accurate pixel selections for a material selection and a sub-material selection. In some embodiments, the multi-resolution input manager 1002 determines multiple resolution digital images from the input image by scaling the input image. Furthermore, the multi-resolution input manager 1002 partitions the multiple resolution digital images into non-overlapping image partitions (e.g., image patches) representing localized regions of the image. The multi-resolution input manager 1002 provides the image partitions to the feature extraction manager 1004.

As further shown in FIG. 10, the multi-scale selection system 106 includes the feature extraction manager 1004. In one or more embodiments, the feature extraction manager 1004 utilizes an encoder of a material detection neural network 108 to extract features from the image partitions provided by the feature extraction manager 1004. In particular, the feature extraction manager 1004 utilizes the encoder such as a self-supervised vision transformer to iteratively refine the image features of the image partitions. In one or more embodiments and for each of the image partitions, the feature extraction manager 1004 generates multi-scale image features for multiple levels of resolution or scale. In some cases, the feature extraction manager 1004 utilizes transformer blocks to generate local and global features. In some cases, the feature extraction manager 1004 and utilizes upscaling operators to process the combined features of the local and global features and generate the multi-scale image features.

As also shown in FIG. 10, the multi-scale selection system 106 utilizes the feature aggregation manager 1006 to generate multi-scale aggregated features from the multi-scale image features. For example, the feature aggregation manager 1006 merges, upscales and/or downscales, and concatenates sets of the multi-scale image features at each scale to generate the multi-scale aggregated features. For example, the feature aggregation manager 1006 merges multi-scale image features generated from each resolution of the input image and upscales/downscales the merged multi-scale image features to a uniform resolution. In some embodiments, the feature aggregation manager 1006 concatenates the scaled merged multi-scale image features along a feature dimension to generate the aggregated multi-scale features.

In one or more embodiments, the multi-scale selection system 106 utilizes the feature processing manager 1008 to further refine the multi-scale aggregated features. For example, the feature processing manager 1008 utilizes a decoder of the material detection neural network 108 to generate the material selection and the sub-material selection from weighted multi-scale aggregated features. In some embodiments, the feature processing manager 1008 refines the multi-scale aggregated features utilizing cross-similarity feature weighting. In some cases, the feature processing manager 1008 generates a material similarity score and a sub-material similarity score utilizing the cross-similarity feature weighting on the multi-scale aggregated features. In certain cases, the feature processing manager 1008 compares the material similarity score to a material matching threshold to generate the material selection and the sub-material similarity score to a sub-material matching threshold to generate the sub-material selection.

Additionally, as shown, the multi-scale selection system 106 includes the data storage manager 1010. In particular, the data storage manager 1010 (implemented by one or more memory devices) stores input images, material similarity score, material matching threshold, sub-material similarity score, sub-material matching threshold, material selection, and sub-material selection. material matching threshold. The data storage manager 1010 facilitates the use of digital images by the multi-scale selection system 106.

Each of the components 1000-1010 of the multi-scale selection system 106 includes software, hardware, or both. For example, the components 1000-1010 include one or more instructions stored on a computer-readable storage medium and executable by processors of one or more computing devices, such as a client device or server device. When executed by the one or more processors, the computer-executable instructions of the multi-scale selection system 106 causes the computing device(s) to perform the methods described herein. Alternatively, the components 1000-1010 include hardware, such as a special-purpose processing device to perform a certain function or group of functions. Alternatively, the components 1000-1010 of the multi-scale selection system 106 include a combination of computer-executable instructions and hardware.

Furthermore, the components 1000-1010 of the multi-scale selection system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 1000-1010 of the multi-scale selection system 106 are implemented as a stand-alone application, such as a desktop or mobile application. Furthermore, in some embodiments, the components 1000-1010 of the multi-scale selection system 106 are implemented as one or more web-based applications hosted on a remote server. Alternatively, or additionally, the components 1000-1010 of the multi-scale selection system 106 are implemented in a suite of mobile device applications or “apps.” For example, in one or more embodiments, the multi-scale selection system 106 comprises or operates in connection with digital software applications such as: ADOBE® PHOTOSHOP®, ADOBE® PHOTOSHOP® LIGHTROOM, ADOBE® PHOTOSHOP® EXPRESS, and ADOBE® AFTER EFFECTS®. The foregoing are either registered trademarks or trademarks of Adobe Inc. in the United States and/or other countries.

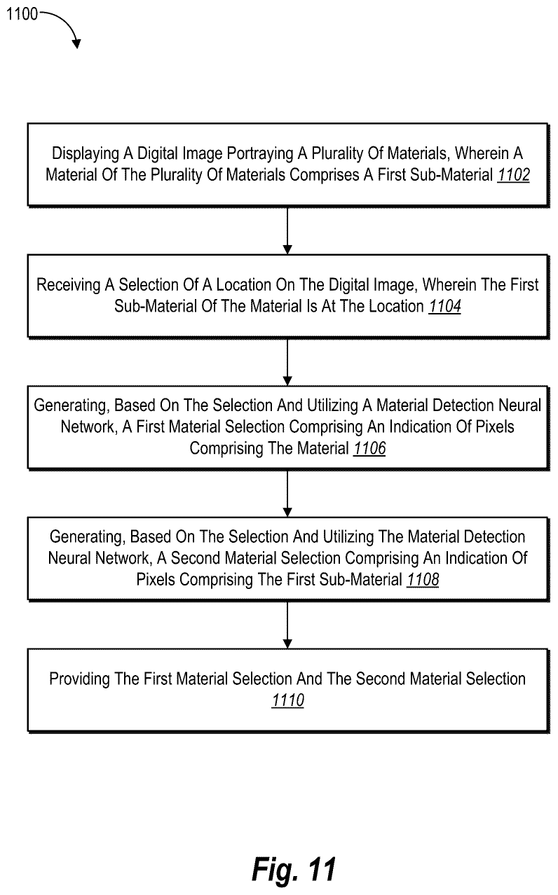

FIGS. 1-10, the corresponding text, and the examples provide a number of different methods, systems, devices, and non-transitory computer-readable media of the multi-scale selection system 106. In addition to the foregoing, one or more embodiments are also described in terms of flowcharts comprising acts for accomplishing a particular result, as shown in FIG. 11. In some embodiments, the acts shown in FIG. 11 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 11. In some embodiments, a system is configured to perform the acts of FIG. 11. Alternatively, the acts of FIG. 11 are performed as part of a computer-implemented method.

FIG. 11 illustrates a flowchart of a series of acts for generating a predicted document-summary consistency for a digital summary of a digital document in accordance with one or more embodiments. While FIG. 11 illustrates acts according to one embodiment, alternative embodiments omit, add to, reorder, and/or modify any acts shown in FIG. 11.

FIG. 11 illustrates an example series of acts 1100 for utilizing a multi-scale selection system 106 to generate a first material selection and a second material selection. In particular, in certain embodiments, the series of acts 1100 includes an act 1102 of displaying a digital image portraying a plurality of materials, wherein a material of the plurality of materials comprises a first sub-material. Specifically, in one or more embodiments, the act 1102 includes displaying, via a graphical user interface, a digital image portraying a plurality of materials, wherein a material of the plurality of materials comprises a first sub-material and a second sub-material, wherein the first sub-material is visually distinct from the second sub-material. In particular, in certain embodiments, the series of acts 1100 includes an act 1104 of receiving a selection of a location on the digital image, wherein the first sub-material of the material is at the location. In particular, in one or more embodiments, the act 1104 includes receiving, via an interaction with the graphical user interface, a selection of a location on the digital image, wherein the first sub-material of the material is at the location. As illustrated, in some embodiments, the series of acts 1100 also includes an act 1106 of generating, based on the selection and utilizing a material detection neural network, a first material selection comprising an indication of pixels comprising the material. In particular, in one or more embodiments, the act 1106 includes generating, based on the selection and utilizing a material detection neural network, a first material selection comprising an indication of pixels of the digital image comprising the material. In one or more embodiments, the series of acts 1100 also includes an act 1108 of generating, based on the selection and utilizing the material detection neural network, a second material selection comprising an indication of pixels comprising the first sub-material. In particular, in one or more embodiments, the act 1108 includes generating, based on the selection and utilizing the material detection neural network, a second material selection comprising an indication of pixels of the digital image comprising the first sub-material. In certain embodiments, the series of acts 1100 also includes an act 1110 of providing the first material selection and the second material selection. In some embodiments, the act 1110 includes providing, via the graphical user interface, the first material selection and the second material selection.

In addition (or in the alternative) to the acts described above, in certain embodiments, the multi-scale selection system series of acts 1100 also includes generating the first material selection comprises utilizing a first channel of a material selection head of the material detection neural network trained utilizing images with material annotations at a spatially varying bidirectional reflectance distribution level. In some embodiments, the series of acts 1100 also includes generating the second material selection comprises utilizing a second channel of a material selection head of the material detection neural network trained utilizing images with material annotations at a bidirectional reflectance distribution level. Moreover, in one or more embodiments, the multi-scale selection system 106 series of acts 1100 includes an act wherein the digital image comprises an additional material that shares a semantic class with the material. Further still, in some embodiments, the multi-scale selection system 106 series of acts 1100 includes an act wherein generating the first material selection comprises selecting the pixels of the digital image comprising the material and excluding pixels of the digital image comprising the additional material.

Furthermore, in one or more embodiments, the multi-scale selection system series of acts 1100 includes receiving, via an additional interaction with the graphical user interface, an additional selection of an additional location on the digital image, wherein the second sub-material of the material is at the additional location. Moreover, one or more embodiments, the series of acts 1100 includes generating, based on the additional selection and utilizing the material detection neural network, a third material selection comprising an indication of pixels of the digital image comprising the second sub-material. Further still, in one or more embodiments, the series of acts 1100 includes providing, via the graphical user interface, the third material selection.

Moreover, in one or more embodiments, the series of acts 1100 includes receiving a user input indicating a modification to a material matching threshold. In certain embodiments, the series of acts 1100 further includes generating, based on the modification to the material matching threshold, a modification to the first material selection. Moreover, one or more embodiments, the series of acts 1100 includes providing, via the graphical user interface, the modification to the first material selection. Furthermore, in one or more embodiments, the series of acts 1100 includes receiving an additional user input indicating a modification to a sub-material matching threshold. Moreover, in one or more embodiments, the series of acts 1100 includes generating, based on the modification to the sub-material matching threshold, a modification to the second material selection. In one or more embodiments, the series of acts 1100 includes providing, via the graphical user interface, the modification to the second material selection.

Further still, in one or more embodiments, the series of acts 1100 includes generating, from the digital image at a first resolution, a second digital image by scaling the digital image to a second resolution. In one or more embodiments, the series of acts 1100 further includes generating image partitions by partitioning the second digital image into non-overlapping image patches. In addition, in one or more embodiments, the series of acts 1100 includes providing the digital image and the image partitions to the material detection neural network. Furthermore, in one or more embodiments, the series of acts 1100 includes an act wherein generating, utilizing the material detection neural network, the first material selection and the second material selection comprises utilizing the digital image and the image partitions.

In addition, in one or more embodiments, the series of acts 1100 includes an act wherein generating, utilizing the material detection neural network, the first material selection and the second material selection comprises generating, utilizing an encoder of the material detection neural network, a first set of multi-scale image features from the digital image. Moreover, in one or more embodiments, the series of acts 1100 includes an act wherein generating, utilizing the material detection neural network, the first material selection and the second material selection comprises generating, utilizing the encoder of the material detection neural network, a second set of multi-scale image features from the image partitions. In one or more embodiments, the series of acts 1100 includes an act wherein generating, utilizing the material detection neural network, the first material selection and the second material selection comprises aggregating the first set of multi-scale image features and the second set of multi-scale image features.

Furthermore, in one or more embodiments, the series of acts 1100 includes generating, utilizing an encoder of a material detection neural network, a first set of multi-scale image features from a digital image at a first resolution. In some embodiments, the series of acts 1100 also includes generating, utilizing the encoder of the material detection neural network, a second set of multi-scale image features from the digital image at a second resolution. Moreover, in one or more embodiments, the multi-scale selection system 106 series of acts 1100 includes generating, utilizing an aggregation module of the material detection neural network, multi-scale aggregated features by aggregating the first set of multi-scale image features and the second set of multi-scale image features. Further still, in some embodiments, the multi-scale selection system 106 series of acts 1100 includes generating, from the multi-scale aggregated features and utilizing a decoder of the material detection neural network, a material selection comprising an indication of pixels of the digital image comprising a material portrayed in the digital image.

Furthermore, in one or more embodiments, the multi-scale selection system series of acts 1100 includes training the material detection neural network utilizing training images comprising hierarchical materials, wherein the hierarchical materials comprise a material composed of a first sub-material and a second sub-material, wherein the first sub-material is visually distinct from the second sub-material. Further still, in one or more embodiments, the series of acts 1100 includes generating, from the multi-scale aggregated features and utilizing the decoder of the material detection neural network, a second material selection comprising an indication of pixels of the digital image comprising a first sub-material, wherein the material comprises the first sub-material and a second sub-material and the first sub-material is visually distinct from the second sub-material.

Moreover, in one or more embodiments, the series of acts 1100 includes generating, from the digital image at the second resolution, image partitions by partitioning the digital image at the second resolution into non-overlapping image patches. In certain embodiments, the series of acts 1100 further includes an act wherein generating, utilizing the encoder of the material detection neural network, the second set of multi-scale image features comprises generating the second set of multi-scale image features from the image partitions. Moreover, one or more embodiments, the series of acts 1100 includes an act wherein generating the multi-scale aggregated features comprises concatenating the first set of multi-scale image features and the second set of multi-scale image features along a feature dimension.

Moreover, one or more embodiments, the series of acts 1100 includes generating, utilizing the encoder of the material detection neural network, a third set of multi-scale image features from the digital image at a third resolution. Furthermore, in one or more embodiments, the series of acts 1100 includes an act wherein generating, utilizing the aggregation module of the material detection neural network, the multi-scale aggregated features comprises aggregating the first set of multi-scale image features, the second set of multi-scale image features, and the third set of multi-scale image features. Moreover, in one or more embodiments, the series of acts 1100 includes generating an overlay which visually distinguishes the pixels of the digital image comprising the material portrayed in the digital image from other pixels of the digital image. In one or more embodiments, the series of acts 1100 includes generating a binary mask which portrays the pixels of the digital image comprising the material portrayed in the digital image using a first value and portrays the other pixels of the digital image using a second value.

Further still, in one or more embodiments, the series of acts 1100 includes generating the first material selection and the second material selection from features extracted from non-overlapping image patches generated by upscaling and partitioning the digital image. In one or more embodiments, the series of acts 1100 further includes receiving user input indicating a modification to a material matching threshold. In addition, in one or more embodiments, the series of acts 1100 includes generating, based on the modification to the material matching threshold, a modification to the first material selection and a modification to the second material selection. Furthermore, in one or more embodiments, the series of acts 1100 includes providing, via the graphical user interface, the modification to the first material selection and the modification to the second material selection.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., server device(s) 102, client device(s) 110, and computing device 1200). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 1, the computing device 1200 can include one or more processor(s) 1202, memory 1204, a storage device 1206, I/O interfaces 1208 (or “input/output interfaces”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular embodiment.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method comprising:
displaying, via a graphical user interface, a digital image portraying a plurality of materials, wherein a material of the plurality of materials comprises a first sub-material and a second sub-material, wherein the first sub-material is visually distinct from the second sub-material;
receiving, via an interaction with the graphical user interface, a selection of a location on the digital image, wherein the first sub-material of the material is at the location;
generating, based on the selection and utilizing a material detection neural network, a first material selection comprising an indication of pixels of the digital image comprising the material;
generating, based on the selection and utilizing the material detection neural network, a second material selection comprising an indication of pixels of the digital image comprising the first sub-material; and
providing, via the graphical user interface, the first material selection and the second material selection.

2. The method of claim 1, wherein:
generating the first material selection comprises utilizing a first channel of a material selection head of the material detection neural network trained utilizing images with material annotations at a spatially varying bidirectional reflectance distribution level; and
generating the second material selection comprises utilizing a second channel of a material selection head of the material detection neural network trained utilizing images with material annotations at a bidirectional reflectance distribution level.

3. The method of claim 1, wherein:
the digital image comprises an additional material that shares a semantic class with the material; and
generating the first material selection comprises selecting the pixels of the digital image comprising the material and excluding pixels of the digital image comprising the additional material.

4. The method of claim 1, further comprising:
receiving, via an additional interaction with the graphical user interface, an additional selection of an additional location on the digital image, wherein the second sub-material of the material is at the additional location;
generating, based on the additional selection and utilizing the material detection neural network, a third material selection comprising an indication of pixels of the digital image comprising the second sub-material; and
providing, via the graphical user interface, the third material selection.

5. The method of claim 1, further comprising:
receiving a user input indicating a modification to a material matching threshold;
generating, based on the modification to the material matching threshold, a modification to the first material selection; and
providing, via the graphical user interface, the modification to the first material selection.

6. The method of claim 5, further comprising:
receiving an additional user input indicating a modification to a sub-material matching threshold;
generating, based on the modification to the sub-material matching threshold, a modification to the second material selection; and
providing, via the graphical user interface, the modification to the second material selection.

7. The method of claim 1, further comprising:
generating, from the digital image at a first resolution, a second digital image by scaling the digital image to a second resolution;
generating image partitions by partitioning the second digital image into non-overlapping image patches; and
providing the digital image and the image partitions to the material detection neural network;
wherein generating, utilizing the material detection neural network, the first material selection and the second material selection comprises utilizing the digital image and the image partitions.

8. The method of claim 7, wherein generating, utilizing the material detection neural network, the first material selection and the second material selection comprises:
generating, utilizing an encoder of the material detection neural network, a first set of multi-scale image features from the digital image;
generating, utilizing the encoder of the material detection neural network, a second set of multi-scale image features from the image partitions; and
aggregating the first set of multi-scale image features and the second set of multi-scale image features.

9. A system comprising:
a memory component; and
one or more processing devices coupled to the memory component, the one or more processing devices to perform operations comprising:
generating, utilizing an encoder of a material detection neural network, a first set of multi-scale image features from a digital image at a first resolution;
generating, utilizing the encoder of the material detection neural network, a second set of multi-scale image features from the digital image at a second resolution;
generating, utilizing an aggregation module of the material detection neural network, multi-scale aggregated features by aggregating the first set of multi-scale image features and the second set of multi-scale image features; and
generating, from the multi-scale aggregated features and utilizing a decoder of the material detection neural network, a material selection comprising an indication of pixels of the digital image comprising a material portrayed in the digital image.

10. The system of claim 9, further comprising training the material detection neural network utilizing training images comprising hierarchical materials, wherein the hierarchical materials comprise a material composed of a first sub-material and a second sub-material, wherein the first sub-material is visually distinct from the second sub-material.

11. The system of claim 9, further comprising generating, from the multi-scale aggregated features and utilizing the decoder of the material detection neural network, a second material selection comprising an indication of pixels of the digital image comprising a first sub-material, wherein the material comprises the first sub-material and a second sub-material and the first sub-material is visually distinct from the second sub-material.

12. The system of claim 9, further comprising generating, from the digital image at the second resolution, image partitions by partitioning the digital image at the second resolution into non-overlapping image patches;
wherein generating, utilizing the encoder of the material detection neural network, the second set of multi-scale image features comprises generating the second set of multi-scale image features from the image partitions.

13. The system of claim 9, wherein generating the multi-scale aggregated features comprises concatenating the first set of multi-scale image features and the second set of multi-scale image features along a feature dimension.

14. The system of claim 9, further comprising generating, utilizing the encoder of the material detection neural network, a third set of multi-scale image features from the digital image at a third resolution;
wherein generating, utilizing the aggregation module of the material detection neural network, the multi-scale aggregated features comprises aggregating the first set of multi-scale image features, the second set of multi-scale image features, and the third set of multi-scale image features.

15. The system of claim 9, wherein generating the material selection further comprises:
generating an overlay which visually distinguishes the pixels of the digital image comprising the material portrayed in the digital image from other pixels of the digital image; or
generating a binary mask which portrays the pixels of the digital image comprising the material portrayed in the digital image using a first value and portrays the other pixels of the digital image using a second value.

16. A non-transitory computer readable medium storing executable instructions which, when executed by a processing device, cause the processing device to perform operations comprising:
displaying, via a graphical user interface, a digital image portraying a plurality of materials, wherein a material of the plurality of materials comprises a first sub-material and a second sub-material, wherein the first sub-material is visually distinct from the second sub-material;
receiving, via an interaction with the graphical user interface, a selection of a location on the digital image, wherein the first sub-material of the material is at the location;
generating, based on the selection and utilizing a material detection neural network, a first material selection comprising an indication of pixels of the digital image comprising the material;
generating, based on the selection and utilizing the material detection neural network, a second material selection comprising an indication of pixels of the digital image comprising the first sub-material; and
providing, via the graphical user interface, the first material selection and the second material selection.

17. The non-transitory computer readable medium of claim 16, wherein generating the first material selection comprises utilizing a first detection channel of the material detection neural network trained utilizing images with material annotations at a spatially varying bidirectional reflectance distribution level.

18. The non-transitory computer readable medium of claim 16, wherein generating the second material selection comprises utilizing a second detection channel of the material detection neural network trained utilizing images with material annotations at a bidirectional reflectance distribution level.

19. The non-transitory computer readable medium of claim 16, wherein generating, utilizing the material detection neural network, the first material selection and the second material selection comprises generating the first material selection and the second material selection from features extracted from non-overlapping image patches generated by upscaling and partitioning the digital image.

20. The non-transitory computer readable medium of claim 16, further comprising:
receiving user input indicating a modification to a material matching threshold;
generating, based on the modification to the material matching threshold, a modification to the first material selection and a modification to the second material selection; and
providing, via the graphical user interface, the modification to the first material selection and the modification to the second material selection.
